(19) United States
(12) Patent Application Publication
(10) Pub. No.: US 2009/0013188 A1
(43) Pub. Date: Jan. 8, 2009

(54) Search for a Watermark in a Data Signal

(75) Inventors: Mehmet Utku Celik, Eindhoven (NL); Aweke Negash Lemma, Eindhoven (NL); Minne Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/162,369

(22) PCT Filed: Jan. 29, 2007
(86) PCT No.: PCT/IB07/50285

§ 371 Date: Jul. 28, 2008

(30) Foreign Application Priority Data
Jan. 30, 2006 (EP) 06101029.4

(51) Int. Cl. H04L 9/00

(52) U.S. Cl. 713/176

(57) ABSTRACT

The invention relates to a method of searching for a watermark in a data signal, and to a watermark detector, such as a copy-control watermark detector. The search is conducted in order to find a watermark in content which possibly has been attacked and/or altered. The search is conducted by the steps of determining or setting a search space for the data signal, selecting a subspace of the search space, and searching for the presence of the watermark in the subspace. The subspace may be selected from a multitude of regions, the selection e.g. being based on a deterministic or probabilistic function.

### FIELD OF THE INVENTION

The invention relates to a method of searching for a watermark in a data signal, and to a watermark detector, such as a copy-control watermark detector. Moreover, the invention relates to computer readable code.

### BACKGROUND OF THE INVENTION

Illegal copying of digital content, such as audio and video content, is becoming an increasing problem for content owners and many strategies are pursued in order to hinder the distribution of illegal digital content. One possible strategy is to furnish playback apparatuses (players) with a copy-control watermark detector capable of identifying the contents bearing watermarks and limiting the set of available actions (e.g. playback) in accordance with the watermark payload. Before (or during) playback, the player checks the content of the watermark and e.g. refuses to play (or stops playing) in dependence upon the presence of a watermark and/or content of the payload. For instance, a content marked as “theatrical release only” will not play on a home system. To circumvent any restrictions imposed by a watermark, an attacker may manipulate the content. Also incidental attacks may occur.

In order to be robust against a large set of possible attacks, most copy-control watermark detectors perform watermark detection on multiple versions of the content or by using multiple versions of the watermark, versions which are generated by the detector to invert different possible attacks. This process is also known as a search, i.e. the detector searches through different possible attack scenarios. A possible attack often consists of temporal and geometrical distortions. For instance, audio may be slowed down or sped up by a small fraction without causing disturbing perceptual artifacts. To this end, the watermark may be searched at different scale (speed) factors. The complexity of the search procedure, however, increases linearly with the cardinality, or size, of the search space. Performing an exhaustive search, where all possible attack scenarios are searched may be prohibitive for complexity-bound playback apparatuses, e.g. for players where a low complexity in the form of a low cost is paramount.

US patent application 2002/0057823 A1 discloses a method of detecting the presence of a watermark in an image by first identifying those regions of the image that have a high probability that a watermark can be detected in the region, resulting in a shortening of the processing time and reducing the computational power required to find a watermark in an image. The invention however does not deal with detecting a watermark in digital content which possibly has been attacked.

### SUMMARY OF THE INVENTION

The inventors of the present invention have appreciated that an exhaustive search may be impracticable or prohibited in some playback apparatuses, and have in consequence devised the present invention. The present invention seeks to provide an improved means for searching for a watermark in a data signal. Preferably, the invention alleviates, mitigates or eliminates one or more of the above or other disadvantages singly or in any combination.

According to a first aspect of the present invention there is provided, a method of searching for a watermark in a data signal, the method comprising:

determining or setting a search space for the data signal;

selecting a subspace of the search space; and

searching for the presence of the watermark in the subspace.

The invention allows targeting a specific subspace of a search space in which the presence of a watermark is searched. The invention is particularly but not exclusively advantageous for a number of reasons. By limiting the search to a subspace the number of trails is reduced from the size of the search space to the size of the subspace, thereby reducing the complexity of a watermark detector in accordance with the present invention, and thereby reducing the cost of such a watermark detector. The advantage comes at the expense of a probabilistic reduction in detection robustness when compared with the full search strategy. However by comparing with a detector of the same complexity (number of search trials) the number of attacks that can be searched is effectively increased. By setting selection criteria which are not known to an attacker, the attacker is not able to set up a successful attack strategy. On playback apparatuses on which an exhaustive search cannot be implemented, the present invention provides an advantageous alternative. Moreover, the present invention is superior to the exhaustive search in some regards. Each detection trial in any search strategy also brings along a small false positive probability, i.e. a probability of falsely detecting a watermark while there is none. When multiple detections are performed, the effective false positive probability is the sum of individual false positive probabilities. Therefore, searching through all possible attacks may yield unacceptable false positive probability values. Furthermore, the time it takes to perform a search in accordance with the present invention may be less than the time it takes to perform an exhaustive search.

Claim 2 describes an advantageous embodiment where the search space is independent of the signal content, e.g. image or audio characteristics. Versatile or even universal search strategies may thereby be set up.

Claims 3 to 5 describe advantageous embodiments of providing regions from which the subspace may be selected.

Claims 6 and 7 describe advantageous embodiments of providing the subspace.

Claims 8 and 9 describe advantageous embodiments where the selection of the subspace and/or the determination of the subspace is based on a deterministic or probabilistic function, a large number of search strategies may thereby be set up. Furthermore, a dynamic element is introduced into the selection of the subspace. It is thereby rendered difficult or even impossible for an attacker to set up a successful attack strategy.

Claim 10 describes an advantageous embodiment where a payload is extracted. Information relating to the content of the data signal may thereby be conveyed to an apparatus playing the content.

Claim 11 describes an advantageous embodiment where an operation state of an apparatus in which the method is implemented is set, either in accordance with the watermark or in accordance with an extracted payload. A content owner can thereby control that the operation state of an apparatus is set in accordance with the rights relating to digital content.

According to a second aspect of the invention, there is provided a watermark detector for searching for a watermark in a data signal, the watermark detector comprising:

search space module for determining or setting the search space for the data signal;

selector module for selecting a subspace; and

detector module for searching for the presence of a watermark in the subspace.

The invention according to the second aspect is particularly but not exclusively advantageous since a watermark detector, such as a copy-control watermark detector with reduced complexity and thereby reduced cost may be provided. The watermark detector may be provided by implementing the method of the first aspect of the invention.

According to a third aspect of the invention, there is provided computer readable code for implementing the method according to the first aspect of the invention, or for controlling a watermark detector according to the second aspect of the invention.

In general the various aspects of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 illustrates an embodiment of a scheme of searching for a watermark in a data signal;

FIG. 2 schematically illustrates a search space which has been divided into nine regions;

FIG. 3 illustrates alternative embodiments of a search space; and

FIG. 4 schematically illustrates an embodiment of a watermark detector in accordance with the present invention.

### DESCRIPTION OF EMBODIMENTS

An embodiment of the invention is aimed at reducing the computational complexity of the search process in a copy-control watermark detection scheme. This is an advantageous embodiment, since copy-control watermark detectors are subdued to stringent complexity requirements. Nevertheless, the invention is applicable for other types of watermark detection schemes as well.

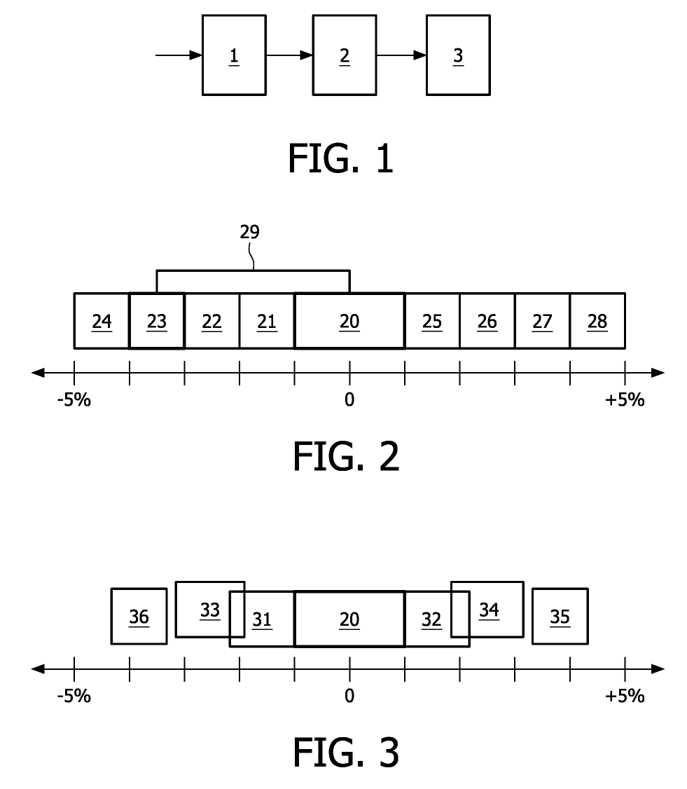

FIG. 1 illustrates an embodiment of a scheme of searching for a watermark in a data signal, the scheme of FIG. 1 may be implemented in a copy-control watermark detector in accordance with the present invention. The watermark detector may be part of a consumer playback apparatus, such as a DVD player or any other type of player.

An attacker may prevent watermark detection of a restricting watermark by changing the scale of, e.g. resizing, the signal content. A scale change of ±5% may be imperceptible to an end user, and an attacker may try to change the scale within this interval. Searching this range on a fine grid may be too time-consuming for the detector, and the search may be limited to ±1%. This may however cause the smart attacker to make changes outside this range, e.g. 2%. The attacker may verify on his player whether or not the content can be played.

In the present invention a limited search is performed, in that a search is performed in a subspace of the entire search space. Limiting the search to a subspace significantly reduces the detector complexity. Since the entire range is not searched, a valid watermark may be missed in the search process. Nonetheless the selection of the subspace may be done in a variety of ways thereby introducing uncertainty for the attacker, and thereby rendering it difficult or even impossible for the attacker to test the attack strategy for an ensemble of players.

In an embodiment of the present invention, the following steps are conducted. In a first step, a search space of the data signal is determined 1. The search space may relate to a parameter of the signal content, and to a size of the space. The search space may, for example be determined by deciding that the search should be conducted in a scale parameter, e.g. a resizing parameter of the images and that the searching should be conducted in the resizing range of ±5%. Having determined the search space, a subspace is selected 2, such as the combination of a base region ranging from −1 to +1 and the region between −3 and −4. In subsequent step, the presence of a watermark is searched 3 in the selected subspace. The searching of the watermark may e.g. be conducted by generating modified versions of the content in accordance with the selected search parameter(s) and search for the watermark in each of the modified versions, the searching may also be conducted by generating modified versions of the watermark itself and search the same content with the modified watermarks.

FIG. 2 schematically illustrates a search space which has been divided into nine regions, a base region 20 from −1 to +1, and four negative and four positive regions defined by the boundaries [+1, ±2], [±2, ±3], [±3, ±4], [±4, ±5] 21-28. The term region refers to possible parameter ranges from which a subspace can be selected. In an embodiment a player is assigned a random, but static, subspace 29. For example, the union of the base region 20 and the region 23 ranging from −3 to −4. In this situation the subspace is discontinuous. The base region may be included to make sure that the detection is successful on all players when there is no attack. The base region may be predetermined, i.e. a setting of an apparatus may be such that a given base region is used. By searching only the subspace, the complexity is much less than searching the entire interval of ±5% (the exhaustive search). Yet, the search potential includes all of the large range. An attacker can therefore not guarantee playback by choosing 2%, since players where the subspace denoted 25 is selected will not play. To guarantee playback the attacker has to go outside ±5%, which will cause disturbing perceptual artifact. If 2% is chosen regardless, some of the buyers of illegal content will be annoyed to discover that the content does not play on their apparatus.

A number of search spaces may be selected. The search space may depend upon the type of data signal. One type of search space may be applied for audio content and another may be applied for video content. The search space may be defined in terms of a scale parameter, e.g. speed-up/speed-down of the audio/video content. For video content, another example of a scale parameter may be resizing, such as stretching. Other examples of parameters defining the search space may be such parameters as rotation for video content, and cropping where a part of the audio or the images is deleted. The search space may be one-dimensional or multidimensional. A 2D search space may e.g. be taken as the combination of resizing and rotation, the search is for example then performed in the 2D subspace defined by a base region and a region between −3 and −4% as the first dimension and the region between 0 and 1 degree rotation as the second dimension. The search space is independent of the signal content and relate only to the parameter or parameters being searched for. It is to be understood that other types of search spaces may be used as well, the above examples are only given as illustrative examples.

FIG. 2 illustrates an embodiment of a division of a search space into regions. The regions may be defined in a number of ways. In FIG. 2, the regions are non-overlapping since each region abuts to an adjacent region. FIG. 3 illustrates alternative embodiments of a search space. In FIG. 3, the region 31 partly overlaps with the regions 32, and likewise for the regions 32 and 34. By overlapping regions, the attacks falling within the overlap are detected using different subspaces. For example a resizing of 2% is detected both with a subspace including the region denoted 32, and with a subspace including the region denoted 34. The boundaries between regions may be chosen to be continuous, or non-continuous. The boundary between the regions denoted 34 and 35 is non-continuous. Non-continuous boundaries may be harder to detect for an attacker.

The specific search space (the search parameter or parameters) as well as the characteristics of the search space (the size of the search space, the number of regions, the placement of the regions, etc.) may be fixed within a player. A player may be born with a given search space, alternatively a player may be born with a predetermined set of search spaces which are chosen by the player (this is elaborated upon below). Likewise may a player be born with a multitude of predetermined regions from which the subspace may be selected. A player may be equipped with a functionality of creating a relevant set of regions, the placement of these regions and the size of the search space.

The function that selects the subspace and/or the specific search space may be probabilistic or deterministic. A non-exhaustive list of examples of functions may include functions that are:

based on apparatus ID. Each apparatus contains an ID, and rules may be set up which in accordance with a given apparatus ID selects a subspace.

based on an internal clock or other timestamp, e.g. a timestamp conveyed by the content (e.g. a timestamp of a disc or other type of record carrier). A simple rule may be that each week (or other time period), a new subspace is selected. An owner of an illegal copy may then play the copy some weeks, but not other weeks (or other time periods).

based on content ID, such as a robust hash derived form the content.

based on a playback counter, e.g. every time new content is played, a different subspace is selected.

These and other functions may be combined.

In a probabilistic selection a random subspace is randomly or pseudo-randomly selected based on any of the above or other examples. The pseudo-random probabilistic selection may be implemented by using a pseudo-random number generator in conjunction with a secret key and one or more of the above values (e.g. the apparatus ID). The random probabilistic selection may be implemented by using a real random number generator, such as hardware that translates noise in RF into truly random bits. In a deterministic selection, rules are implemented on how to select a subspace. For an attacker or owner of illegal content, it may nevertheless still appear random when he or she is able to play the content since the rules are not known to the attacker or owner.

In an embodiment a player may be set to search for resizing in the range ±5% and regions as illustrated in FIG. 2 may be set. The output of the function may then simply point to which of the regions that is selected as the subspace. In another embodiment, in a given number of apparatuses the subspace is set to be the base region in combination with a first region, in a given number of other apparatuses the subspace is set to be the base region in combination with a second region, and so forth. In this way no computing power is need for determining or setting the search space and for selecting the subspace. Nevertheless the effect for an attacker may be similar as to more advanced embodiments.

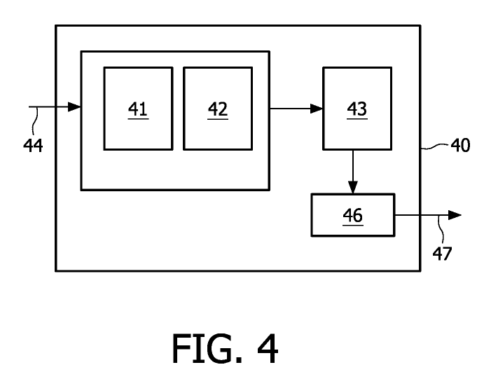

FIG. 4 schematically illustrates an embodiment of a watermark detector 40, such as a copy-control watermark detector, in accordance with the present invention.

A data signal is inputted 44 into the detector. The detector comprises a search space module 41 and a selector module 42. The search space module either determines the search space or has access to a setting of the search space, such as a predetermined setting of the search parameter, possible search space regions, etc. Having selected a subspace, the presence of a watermark in the subspace is searched for in a detector module 43. The detector module may generate several outputs, for example, that a watermark was not found, that a watermarks was indeed found, a found watermark, a payload, etc. The detector module may apply a correlation-based detection method or other methods for detecting a watermark. The output of the detector module is inputted into the operation state module 46 which outputs an operation state 47 of the apparatus. The operation state may be that no watermark was found or that a non-restricting watermark was found, in which case the content may be played on the player. The operation state may also be that a watermark is found or that the watermark has been attacked, in which case the content may not be played on the player. Other operation states may also be set.

Other modules not shown on FIG. 4 may be present in other embodiments, likewise not all modules shown on FIG. 4 need be present in a given embodiment. In the situation that the detector is implemented in software, a module may be a software module suitable for implementing the functionality of the module.

The invention can be implemented in any suitable form including hardware, software, firmware or any combination of these. The invention or some features of the invention can be implemented as computer software running on one or more data processors and/or digital signal processors. The elements and components of an embodiment of the invention may be physically, functionally and logically implemented in any suitable way. Indeed, the functionality may be implemented in a single unit or module, in a plurality of units or modules or as part of other functional units or modules. As such, the invention may be implemented in a single unit, or may be physically and functionally distributed between different units and processors.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. Method of searching for a watermark in a data signal, the method comprising:
determining a search space for the data signal;
selecting a subspace of the search space; and
searching for the presence of the watermark in the subspace.

2. Method according to claim 1, wherein the search space is independent of the signal content.

3. Method according to claim 1, wherein the subspace is selected from a multitude of predetermined regions.

4. Method according to claim 3, wherein at least one of the predetermined regions at least partly overlaps with another region.

5. Method according to claim 3, wherein at least one of the predetermined regions is discontinuous.

6. Method according to claim 1, wherein the subspace is discontinuous.

7. Method according to claim 1, wherein the subspace includes a predetermined base region.

8. Method according to claim 1, wherein the selection of the subspace is based on a deterministic function or on a probabilistic function.

9. Method according to claim 1, wherein the determination or setting of the subspace is based on a deterministic function or on a probabilistic function.

10. Method according to claim 1, wherein in the situation that a watermark is found in the subspace, the method further comprising extracting a payload of the watermark.

11. Method according to claim 1, wherein in the situation that a watermark is found in the subspace, the method further comprising the setting an operation state of an apparatus in which the method is implemented, the operation state optionally being set in accordance with a payload.

13. Watermark detector for searching for a watermark in a data signal, the watermark detector comprising:
a search space module for determining or setting the search space for the data signal;
a selector module for selecting a subspace; and
a detector module for searching for the presence of a watermark in the subspace.

14. (canceled)
